(19) United States
(12) Patent Application Publication
(10) Pub. No.: US 2008/0219465 A1
(43) Pub. Date: Sep. 11, 2008

(54) NOISE CONTROL DEVICE AND METHOD

(75) Inventor: Hiroaki Miura, Kamakura-shi (JP)

Correspondence Address: YOUNG & BASILE, P.C., 3001 WEST BIG BEAVER ROAD, SUITE 624, TROY, MI, 48084, US

(73) Assignee: NISSAN MOTOR CO., LTD., Yokohama-shi (JP)

(21) Appl. No.: 12/022,542

(22) Filed: Jan. 30, 2008

(30) Foreign Application Priority Data
Feb. 28, 2007 (JP) 2007-050515

(51) Int. Cl. G10K 11/16

(52) U.S. Cl. 381/71.4; 381/71.8

(57) ABSTRACT

A noise control device and method effectively reduce noise throughout a broad frequency band. A noise detecting part can detect the noise from a noise source. A stimulus source control signal is output according to a frequency of the noise detected. A stimulus source is provided based on the stimulus source control signal. A sound absorptivity variable member changes sound absorptivity against the noise responsive to the stimulus source.

### CROSS-REFERENCE TO RELATED APPLICATION

This application claims priority from Japanese Patent Application Serial No. 2007-050515, filed Feb. 28, 2007, which is incorporated herein in its entirety by reference.

### TECHNICAL FIELD

The invention generally relates to a noise control device and method, and more particularly to a noise control device and method for providing internal silence by reducing the noise generated from a noise source.

### BACKGROUND

To promote health and comfortable lifestyle, achieving internal silence by reducing the noise generated from a noise source (e.g., mechanical structures such as an internal combustion engine of a vehicle) is desirable.

For example, a technique referred to as active noise control has been introduced in the art in order to reduce the noise. The active noise control technique is designed to reduce or counter the noise by generating another sound wave, which has the same amplitude as the noise but an opposite phase, thereby interfering with the noise. This is based on the concept that the sound is a type of wave phenomenon that propagates through the air by the density change of the air.

As for the technique of reducing the noise using active noise control, Japanese Patent Application Laid-Open No. 2005-280650 discloses a technique for reducing vehicular interior noise by detecting the noise invading into the vehicle by means of a microphone. Then, a sound wave (“noise damping wave”) is generated to counter the noise by using a speaker installed inside the vehicle so as to reduce the noise generated while driving, for example.

Japanese Patent Application Laid-Open No. 2005-120833 discloses another technique for reducing noise that invades into the inside of a vehicle. For example, such a technique uses a variable resonator structure in order to change the sound absorbing property of a sound absorbing member.

### BRIEF SUMMARY

Embodiments of a noise control device and method are taught herein that make it is possible to effectively reduce the noise in a broad frequency band from the low frequency band to the high frequency band using only a small area. One noise control device includes, for example, a noise detecting part configured and arranged to detect a noise generated from a noise source, a stimulus source control part configured to output a stimulus source control signal according to a frequency of the noise, a stimulus source providing part configured to provide a stimulus source based on the stimulus source control signal and a sound absorptivity variable member configured to change sound absorptivity against the noise in response to receiving the stimulus source.

One embodiment of a noise control method taught herein comprises, by example, detecting a noise generated from a noise source, outputting a stimulus source control signal according to a frequency of the noise and providing a stimulus source based on the stimulus source control signal to a sound absorptivity variable member configured to change sound absorptivity against the noise in response to receiving the stimulus source.

### BRIEF DESCRIPTION OF THE DRAWINGS

The description herein makes reference to the accompanying drawings wherein like reference numerals refer to like parts throughout the several views, and wherein:

FIG. 1 is a block diagram schematically illustrating a noise control device constructed in accordance with a first embodiment of the invention;

FIG. 2 is an operational flow chart for the noise control device according to FIG. 1;

FIG. 3 shows an exemplary arrangement of a sound absorptivity variable member of embodiments of a noise control device;

FIG. 4 shows another exemplary arrangement of a sound absorptivity variable member of embodiments of a noise control device;

FIG. 5 is a block diagram schematically illustrating a noise control device constructed in accordance with a second embodiment of the invention;

FIG. 6 is an operational flow chart for the noise control device according to FIG. 5;

FIG. 7 is a block diagram schematically illustrating a noise control device constructed in accordance with a third embodiment of the invention;

FIG. 8 is an operational flow chart for the noise control device according to FIG. 7; and

FIG. 9 shows a measuring device used in a comparison example.

### DETAILED DESCRIPTION OF EMBODIMENTS OF THE INVENTION

The techniques known so far require the following steps: detecting noise; calculating a noise damping wave corresponding to the frequency, amplitude and phase of the detected noise; and outputting the calculated noise damping wave from a speaker. Thus, the noise can be somewhat reduced since the time taken until the noise damping wave is output after detecting the noise is relatively shorter than the time taken to achieve one cycle of the noise frequency. However, where the frequency components of the noise have a high frequency band (such as equal to or higher than 1 kHz), the noise is not effectively reduced since the time taken until the noise damping wave is output after detecting the noise is relatively longer than the time taken to achieve one cycle of the noise frequency. As such, it becomes difficult to match the phase of the noise with that of the noise damping wave.

Further, the variable resonator structure should be increased in size to counter the low frequency band (e.g., the frequency lower than 1 kHz). Thus, such a large structure cannot be used in a confined space such as the interior of a vehicle.

Embodiments of the invention seek to provide a noise control device and method that can effectively reduce the noise from a low frequency band to a high frequency band. Further, the noise control device is desirably sized and configured to be used in a confined space such as the interior of a vehicle.

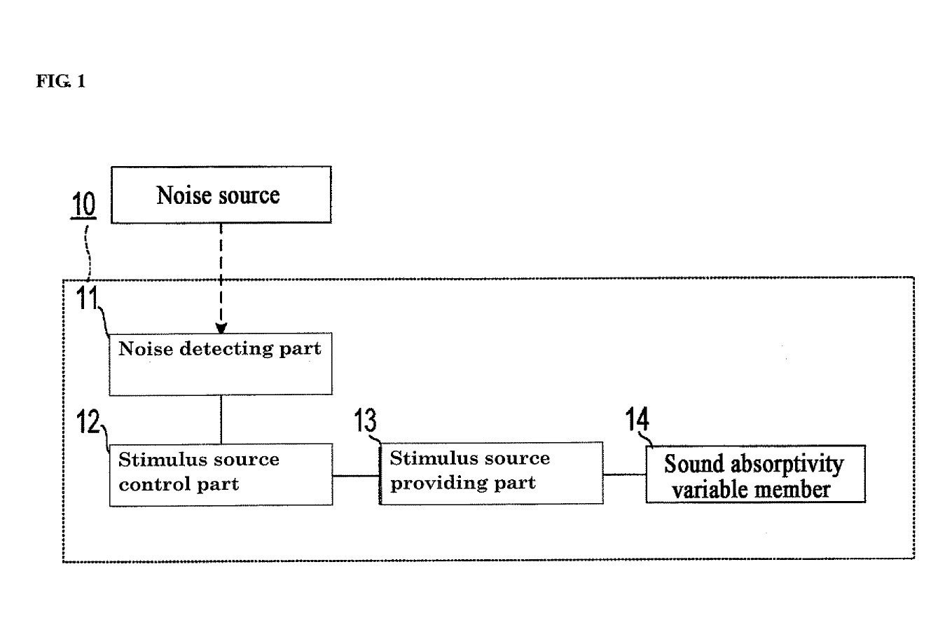

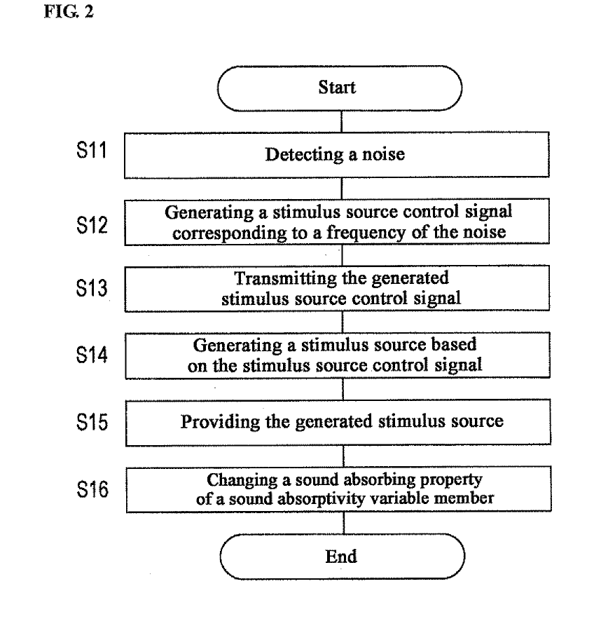

FIGS. 1 and 2 illustrate a noise control device constructed in accordance with a first embodiment of the invention. As shown in FIG. 1, a noise control device 10 of the first embodiment comprises a noise detecting part 11, a stimulus source control part 12, a stimulus providing part 13 and a sound absorptivity variable member 14.

First, in order to facilitate the understanding of the noise control device 10, the sound absorptivity variable member 14 is explained. The sound absorptivity variable member 14 can change the sound absorptivity (that is, the sound absorbing property) against a sound wave when receiving stimulus sources such as temperature, humidity, electricity, light, magnetic source, etc. That is, the sound absorptivity variable member 14 can change the sound absorptivity against the noise by receiving the stimulus source. The sound absorptivity variable member 14 may comprise, for example, an air flow rate variable fabric, an elastic modulus variable fabric or an elastic modulus variable film.

The sound absorptivity variable member 14 may include a stimulus responsive polymer, which generates deformation or stress as a response when receiving the stimulus sources such as temperature, humidity, electricity, light, magnetic source, etc.

For example, the stimulus responsive polymer may comprise a polymer gel in response to a temperature stimulus; a cellulose acetate in response to a humidity stimulus; an ion gel in response to an electric stimulus; and a conductive polymer, a liquid crystal elastomer and a polymer that uses azobenzene in response to a light stimulus. Further, the stimulus responsive polymer in response to the electric stimulus may be a conductive polymer, a liquid crystal elastomer, an ion gel, or a combination thereof.

A fabric, which is prepared by forming the above polymers into fiber, changes the air flow rate when receiving the stimulus source. The difference between the air flow rates changes the peak of absorbing the noise of a specific frequency band so as to cause a difference in the sound absorptivity. Further, the elastic modulus of the polymers is changed before and after receiving the stimulus source. The difference between the above elastic moduli changes the peak of absorbing the noise of a specific frequency band so as to cause a difference in the sound absorptivity. Based on such a principle, the polymer is made into the fiber to form the fabric (an air flow rate variable fabric or an elastic modulus variable fabric) or is formed in a film type (an elastic modulus variable film), and is used as the sound absorptivity variable member 14.

For example, the conductive polymer may comprise conductive polymers selected from the groups consisting of: acetylenic polymer; 5-membered heterocyclic polymer (pyrrolic polymer obtained by polymerizing pyrroles); 3-alkyl pyrrole such as 3-methyl pyrrole, 3-ethyl pyrrole and 3-dodecyl pyrrole; 3,4-dialkyl pyrrole such as 3,4-dimethylpyrrole and 3-methyl-4-dodecyl pyrrole; N-alkyl pyrrole such N-methylpyrrole and N-dodecyl pyrrole; N-alkyl-3-alkyl pyrrole such as N-methyl-3-methylpyrrole and N-ethyl-3-dodecyl pyrrole; and 3-carboxy pyrrole, etc., or thiophenic polymer or isothianaphthenic polymer monomers, phenylenic polymer, anilinic polymer or a copolymer thereof. Further, the materials that can be easily obtained as a fiber may comprise PEDOT/PSS [“Baytron P (registered trademark)” produced by Bayer Company] prepared by doping poly4-styrenesulfonate (PSS) to poly3,4-ethylenedioxythiophene (PEDOT) of thiophenic conductive polymer, or phenylenic poly p-phenylene vinylene (PPV).

Further, as for the conductive polymer, impurities have dramatic effects on the conductivity. The impurities used herein may comprise at least one ion selected from: halide ion such as chloride ion, bromide ion, etc.; perchlorate ion; tetrafluoroborate ion; hexafluoroarsenate ion; sulfate ion; nitrate ion; thiocyanate ion; hexafluorosilicate ion; phosphoric acid based ion such as phosphate ion, phenylphospate ion and hexafluorophosphate ion; trifluoroacetate ion; alkylbenzene sulfonate ion such as tosylate ion, ethylbenzene sulfonate ion, dodecylbenzene sulfonate ion, etc.; alkyl sulfonate ion such as methyl sulfonate ion, ethyl sulfonate ion, etc.; polymer ion such as polyacrylate ion, polyvinylsulfonate ion, polystyrenesulfonate ion, poly(2-acrylamide-2-methylpropanesulfonate) ion, etc. Although the amount of impurities is not specifically limited, one desirable amount is generally in the range of 3 to 50 mass part, and preferably 10 to 30 mass part for 100 mass part conductive polymer.

The liquid crystal elastomer is essentially formed by binding a mesogenic group, which is a central framework of the liquid crystal molecules, into the polymer chain as a pendant chain to generate the liquid crystal phase state of the elastomer. As for the proper elastomer, a polysiloxanes based material can be used to obtain a large deformation.

In addition to the above, the liquid crystal elastomer may comprise polymethacrylate, polychloroacrylate or polystyrene derivative, which exists in a glass state at room temperature. A more preferred elastomer, which exists in a liquid crystal state at room temperature, may comprise polyacrylate, polysiloxane, polyphosphazene or a copolymer thereof.

The mesogenic group can include, for example, alkyl, alkoxy and oxaalkyl group, which have, for example, up to 15 (fifteen) chain elements in a longer axis of a mesogen unit.

Similar to the general polymer synthesis, the elastomer is synthesized, for example, by simple random copolymerization or by a random polymer similar addition reaction with multi-functional cross-linking agent molecule.

Alternatively, a mesogen monomer is copolymerized with a multi-functional comonomer to form a liquid crystal copolymer, which is changed into a network structure by the cross-linking agent in the second reaction process.

As for the amount of incorporating a liquid crystal framework (mesogen group) in a pendant chain and a straight chain of the elastomer, when considering maintaining the shape and increasing the operating amount it is preferred that as a mole ratio, the ratio of the elastomer:the liquid crystal framework, which becomes the framework, is approximately 1:1. Although this ratio is preferred, in actual operation, a ratio from 10:1 to 1:10 is possible. Since the operable amount becomes less, however, such ratios tend to make it more difficult to maintain the shape.

As for the ion gel, an ionic liquid can be incorporated into the gel framework of the polymer.

A method of incorporating the ionic liquid into the framework may comprise previously mixing and dispersing the ionic liquid into a monomer of foam and then blowing the ionic liquid into the framework when performing foaming and polymerizing operations. Alternatively, such a method may comprise incorporating the ionic liquid into the framework by an impregnating operation after a foaming operation. Since the ionic liquid is generally nonvolatile at room temperature, the ionic liquid is retained within the framework. Here, the amount of the ionic liquid to be incorporated into the framework is up to 50% of a weight of the framework material when considering maintaining the framework strength or implementing an actual operation, although the invention is not limited thereto.

An example of the ionic liquid comprises at least one cation or anion, wherein the cation or anion is an organic acid, and ambient temperature molten salt having a molten point equal to or lower than the room temperature, although the present invention is not limited thereto.

The cation of the ionic liquid may include amidinium cation such as imidazolinium cation, imidazolium cation, tetrahydropyrimidinium cation, dihydropyrimidinium cation, etc.; guanidinium cation such as guanidinium cation having an imidazolinium framework, guanidinium cation having an imidazolium framework, guanidinium cation having tetrahydropyrimidinium, guanidinium cation having dihydropyrimidinium framework, etc.; and third grade ammonium cation such as methyldilauryl ammonium. Optionally, the described cation may be used alone or in a combination of two or more cations.

Further, the anion of the ionic liquid may include an organic acid and/or an inorganic acid. The organic acid may comprise, for example, carboxylic acid, sulfuric acid ester, high alkyl ether sulfuric acid ester, sulfonic acid, phosphoric acid ester, etc. The inorganic acid may comprise, for example, super strong acid (e.g., fluoroboric acid, tetrafluoroboric acid, perchloric acid, hexafluorophosphoric acid such as hexafluoroantimonic acid and hexafluoroarsenic acid), phosphoric acid, boric acid, etc. Optionally, the organic and inorganic acids may be used alone or in a combination of two or more acids.

Referring back to FIG. 1, the noise control device 10 of the present embodiment is next explained in more detail.

The noise detecting part 11 is formed on a desired indoor or outdoor position (may be formed within a member separating the indoor from the outdoor) to detect the noise generated from the noise source. For example, the noise detecting part 11 may include a sound level meter or a microphone functioning as a sensor. The noise detecting part 11 converts the noise generated from the noise source (that is, noise) into an electric signal, which is proportional to a magnitude thereof, and transmits the signal to the stimulus source control part 12. The noise detecting part 11 is not specifically limited as long as it has the function of measuring various noises such as normal noise, fluctuating noise, intermittent noise, shock noise, separate shock noise or quasi-steady shock noise, and may be appropriately varied depending on the type of the noise to be measured. Also, although this embodiment describes an example using one noise detecting part, the invention is not limited to such a configuration. That is, the noise may be detected by arranging a plurality of noise detecting parts 11 at various positions.

The stimulus source control part 12 receives the signal from the noise detecting part 11 and generates a stimulus source control signal based on the received signal. The stimulus source control signal generated by the stimulus source control part 12 is transmitted to the stimulus source providing part 13. The stimulus source control signal includes information for instructing a magnitude of the stimulus source assigned to the sound absorptivity variable member 14 or the generation of the stimulus source.

The stimulus source control part 12 generally comprises a central processing unit (CPU) for performing calculation processing required for generating the stimulus source control signal based on signals received from the noise detecting part 11 and a memory unit having an area used for temporarily storing the signals received from the noise detecting part 11 and/or a memory area for storing a program required for generating the stimulus source control signal or performing a frequency analysis of the signal received from the noise detecting part 11.

Further, in some embodiments, a table for generating the stimulus source control signal is stored in the memory unit, and the stimulus source control signal is generated using the table. In such table, the magnitude of the signal from the noise detecting part 11 (the frequency or sound pressure level of the noise) and the stimulus source control signal to be generated are stored in a corresponding relationship. Alternatively, the relationship could be generated mathematically. Although the functions of the stimulus source control part 12 are preferably implemented in software operating on a CPU as described, its functions can be implemented in whole or in part by hardware, including discrete components.

The stimulus source providing part 13 receives the stimulus source control signal from the stimulus source control part 12, generates the stimulus source based on the received stimulus source control signal, and outputs the generated stimulus source to the sound absorptivity variable member 14. The stimulus source providing part 13 is not specifically limited as long as it is capable of generating the stimulus source, where the stimulus source may include, for example, temperature, humidity, electricity, light or magnetic source. For example, the stimulus source providing part 13 can be a direct current stabilization power source such as “AD-8735D” produced by A&D Co., Ltd.

Next, the operational procedures of the noise control device 10 constructed in accordance with the first embodiment are explained in detail with reference to the operational flow chart of FIG. 2.

The first embodiment illustrates an example wherein the sound absorptivity variable member 14, the sound absorptivity of which is changed by receiving an electric stimulus (e.g., a voltage), is applied to a vehicle. Further, although application to the vehicle is explained below, the invention is not limited thereto. That is, the invention may be applied to any place requiring silence, e.g., the interior of a building.

The noise is first detected by the noise detecting part 11 in step S11. The detected noise is converted into an electrical signal proportional to its magnitude and then transmitted to the stimulus source control part 12. Further, the noise detecting part 11 is arranged at an appropriate position for detecting the noise generated from the noise source. For example, an engine mounted in the vehicle or another noise source generated according to an operating state of the vehicle is appropriate.

Next, the stimulus source control part 12 receives the signal from the noise detecting part 11 and generates the stimulus source control signal based on the received signal in step S12. The stimulus source control part 12 generates the stimulus source control signal corresponding to the frequency of the noise detected by the noise detecting part 11 based on the frequency of the noise detected by the noise detecting part 11 and the table for generating the stimulus source control signal. The stimulus source control signal includes information for instructing a magnitude of the voltage, which the stimulus source providing part 13 is configured to generate. Further, the stimulus source control part 12 transmits the generated control signal to the stimulus source providing part 13 at step S13.

Next, in step S14, the stimulus source providing part 13 receives the stimulus source control signal from the stimulus source control part 12 and generates an electric stimulus (voltage) assigned to the sound absorptivity variable member 14 based on the received stimulus source control signal. In this first embodiment, the stimulus source providing part 13 generates the electric stimulus by using a battery mounted in the vehicle. The stimulus source providing part 13 is configured to generate a desired degree of the voltage from the battery via a stabilization power source device (not shown). Further, the stimulus source providing part 13 outputs the generated electric stimulus to the sound absorptivity variable member 14 at step S15.

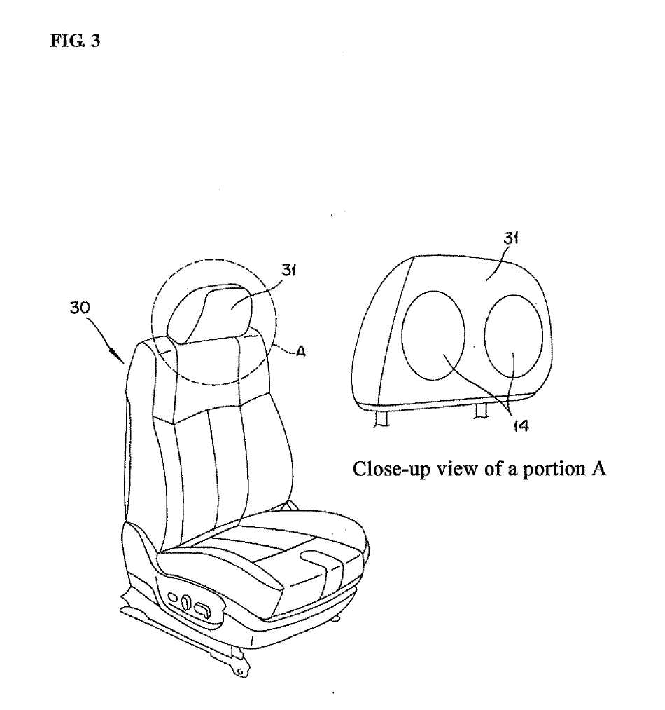

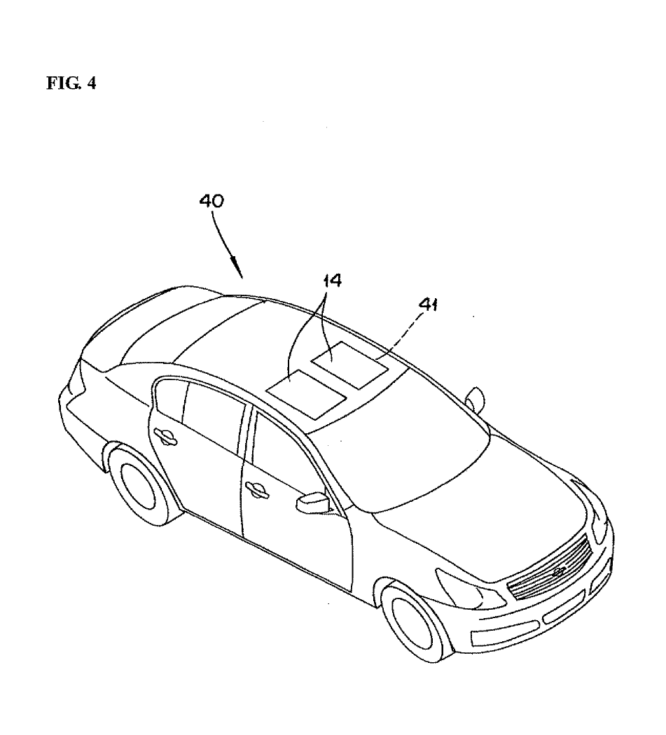

Also, the sound absorptivity variable member 14 receives the electric stimulus output from the stimulus source providing part 13, thereby changing the sound absorptivity against the noise at step S16. As a result, the sound absorptivity of the sound absorptivity variable member 14 against the noise is changed according to the voltage value received from the stimulus source providing part 13. Thus, the noise transmitted from the outside to the vehicle interior becomes reduced. Further, a place for arranging the sound absorptivity variable member 14 is not specifically limited as long as the noise from the outdoor can be effectively reduced. However, for example, the sound absorptivity variable member 14 may be placed in a head rest 31 arranged at an upper portion of the passenger seat 30 (shown in FIG. 3) or at a head lining 41 (protruding inwardly from the indoor top surface of the vehicle) of the vehicle 40 (shown in FIG. 4).

According to the noise control device of the first embodiment, the stimulus source is generated based on the frequency of the noise and is output to the sound absorptivity variable member. Further, by a relatively simple control method, the time until absorbing the sound after detecting the noise can be significantly reduced. Also, since the sound absorptivity variable member includes an air flow rate variable fabric, an elastic modulus variable fabric, an elastic modulus variable film or a combination thereof the passive sound absorbing property of the sound absorbing member can be changed into an active property without using an area equal to or more than a conventional space. Thus, it is possible to provide the noise control device that can effectively reduce the noise from the low frequency band to the high frequency band and can be used in a limited installation space.

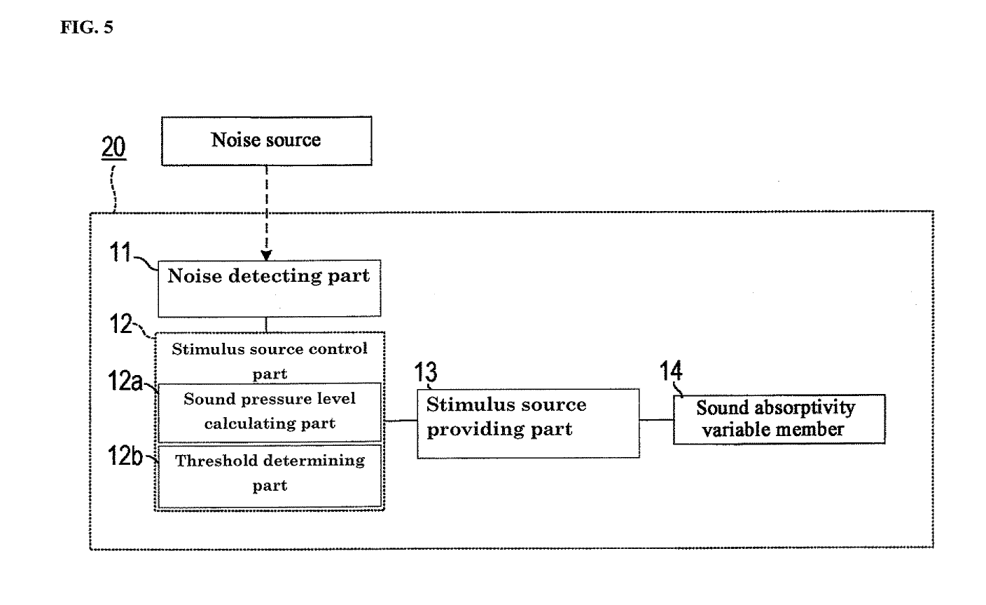

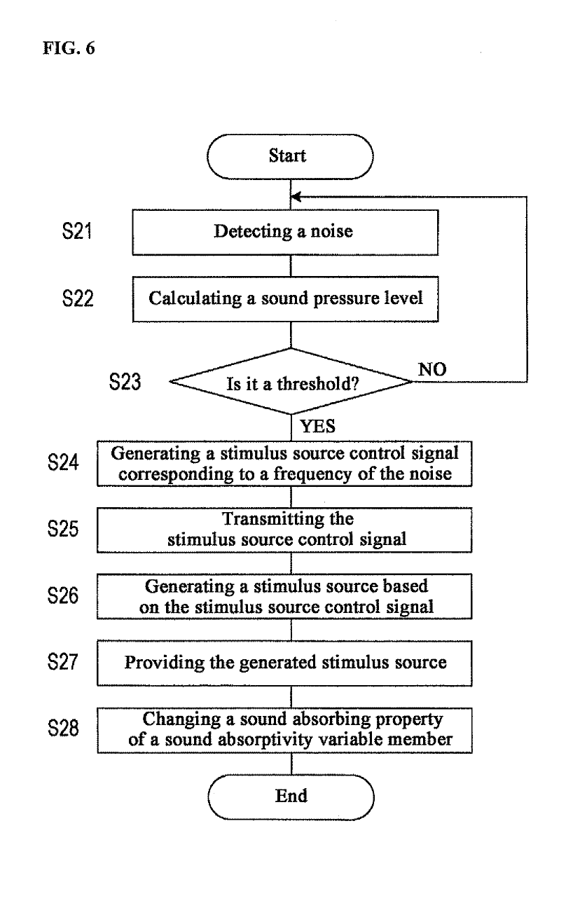

FIGS. 5 and 6 show a noise control device constructed in accordance with a second embodiment of the invention. The first and second embodiments differ from each other in that a sound pressure level calculating part 12a and a threshold determining part 12b are provided in FIG. 5. Since other elements are the same as in FIG. 1, the explanation thereof is omitted herein. Also, since FIG. 5 includes certain elements other than those shown in FIG. 1, the functions of the elements may be different. Only the differences between the two embodiments are explained below.

In the second embodiment, a noise control device 20 is configured to calculate the sound pressure level for each frequency of the noise by performing a frequency analysis of the noise detected by the noise detecting part 11. It then generates a stimulus source control signal by means of the stimulus source control part 12 when the calculated sound pressure level reaches a desired sound pressure level.

The stimulus source control part 12 includes the sound pressure level calculating part 12a and the threshold determining part 12b, and performs the frequency analysis of the noise detected by the noise detecting part II. The stimulus source control part 12 then calculates the sound pressure level for each frequency of the noise, generates the stimulus source control signal when the calculated sound pressure level reaches a desired sound pressure level, and outputs the generated stimulus source control signal. The stimulus source control part 12 also serves as a sound pressure level calculating part and a threshold determining part.

The sound pressure level calculating part 12a analyzes the frequency of the noise detected by the noise detecting part II and calculates the sound pressure level for each frequency of the noise. Since methods of calculating such a sound pressure level are already known, the details thereof are omitted herein. Further, the noise detecting part 11 may be configured to include the function of the sound pressure level calculating part 12a. In such a case, the sound pressure level calculated by the noise detecting part 11 is transmitted to the stimulus source control part 13.

The threshold determining part 12b determines whether the sound pressure level calculated by the sound pressure level calculating part 12a reaches a threshold sound pressure level. The threshold sound pressure level can be any sound pressure level depending on the objectives.

FIG. 6 is an operational flow chart for the noise control device 20 in accordance with the second embodiment. The second embodiment illustrates an example wherein the sound absorptivity variable member 14, the sound absorptivity of which is changed by receiving an electric stimulus (e.g., voltage), is applied to a vehicle. Again, the invention is not limited thereto and may be applied in other locations, such as the interior of a building. Also, the explanation of operation procedures identical to those of FIG. 2 is omitted in this description of FIG. 6.

As shown in FIG. 6, the noise generated from the noise source is first detected by the noise detecting part 11 at step 821. The detected noise is converted into an electrical signal and is transmitted to the stimulus source control part 12.

Next, at step S22, the sound pressure level calculating part 12a receives a signal from the noise detecting part 11 and calculates a sound pressure level for each frequency by analyzing the frequency of the received signal.

The threshold determining part 12b then determines whether the sound pressure level calculated in S22 reaches a threshold sound pressure level at step S23. If the calculated sound pressure level does not reach the threshold sound pressure level, that is, the response to the query of step S23 is “NO,” then the process returns to step S21. However, if the calculated sound pressure level reaches (or exceeds) the threshold sound pressure level, that is, the response to the query of step S23 is “YES,” then a stimulus source control signal is generated based on the frequency reaching the sound pressure level at step 824. Thereafter; the stimulus source control part 12 transmits the generated control signal to the stimulus source providing part 13 at step S25.

Next, at step S26, the stimulus source providing part 13 receives the stimulus source control signal from the stimulus source control part 12 and generates an electric stimulus (e.g., voltage) to be assigned to the sound absorptivity variable member 14 based on the received stimulus source control signal. Then, the stimulus source providing part 13 outputs the generated electric stimulus to the sound absorptivity variable member 14 at step S27.

The sound absorptivity variable member 14 then receives the electric stimulus output from the stimulus source providing part 13 and changes the sound absorptivity against the noise at step S28. The process then ends.

Unlike the first embodiment, when the desired sound pressure level is reached, the stimulus source is generated and applied to the sound absorptivity variable member. As a result, when the noise control device is applied to a place that does not require the noise to be reduced unless a desired sound pressure level is reached, a noise control device with excellent convenience can be provided.

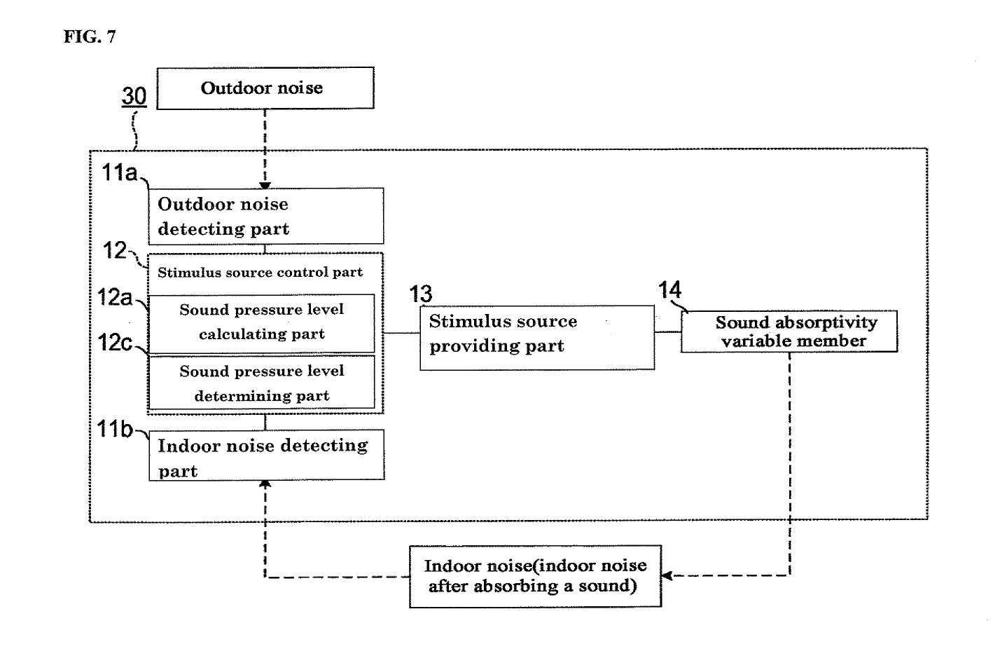

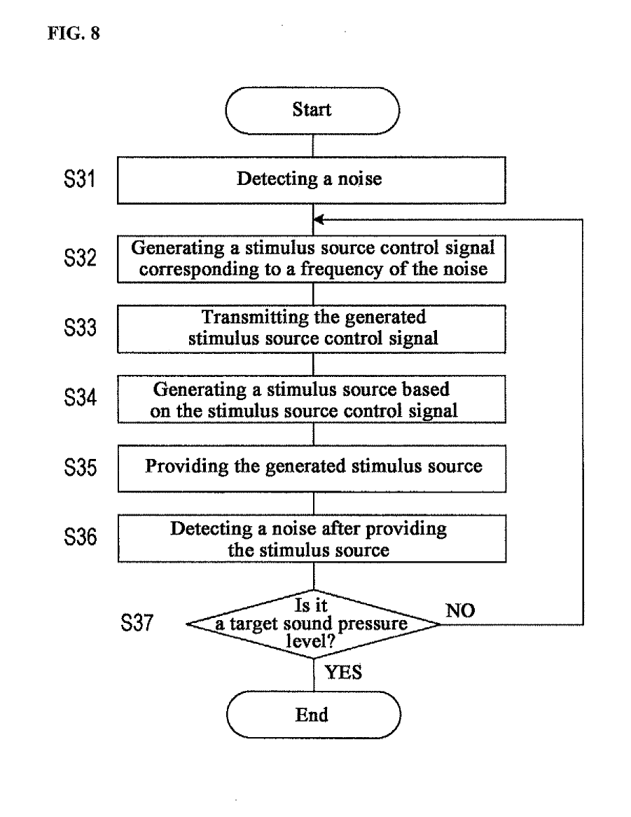

FIGS. 7 and 8 show a noise control device constructed in accordance with a third embodiment of the invention. The second and third embodiments differ from each other in that an outdoor noise detecting part 11a and an indoor noise detecting part 11b for detecting two types of noise are provided in FIG. 7 as the noise detecting part. Also, the third embodiment includes a sound pressure level determining part 12c. Since the other elements are identical to those shown in FIG. 5, the explanation thereof is omitted herein. Also, since FIG. 7 includes certain elements other than those shown in FIG. 5, the functions of the elements may be different. Only the differences between the two embodiments are explained below.

A noise control device 30 of the third embodiment is configured to detect the noise generated from an outdoor noise source and the indoor noise by using the outdoor noise detecting part 11a and the indoor noise detecting part 11b.

The outdoor noise detecting part 11a detects the outdoor noise. The noise detecting part 11 shown in FIGS. 1 and 5 serves as the outdoor noise detecting part 11a. Further, the indoor noise detecting part 11b detects the indoor noise and serves as a second noise detecting part. Although the third embodiment illustrates an example using two noise detecting parts 11a and 11b, the invention is not limited thereto. That is, the invention may include a plurality of noise detecting parts for each noise detecting part 11a and 11b.

The stimulus source control part 12 includes the sound pressure level calculating part 12a and the sound pressure level determining part 12c. The stimulus source control part 12 receives a signal from the outdoor noise detecting part 11a or the indoor noise detecting part 11b, generates the stimulus source control signal based on the received signal, and outputs the generated stimulus source control signal. The stimulus source control signal generated by the stimulus source control part 12 is transmitted to the stimulus source providing part 13.

The sound pressure level calculating part 12a analyzes the frequency of the noise detected by the noise detecting part 11b and calculates the sound pressure level for each frequency of the noise. The sound pressure level calculating part 12a thus serves as a second sound pressure level calculating part. Further, the noise detecting part 11b may be configured to include the function of the sound pressure level calculating part 12a. In such a case, the sound pressure level calculated by the noise detecting part 11b is transmitted to the stimulus source control part 13.

The sound pressure level determining part 12c determines whether the sound pressure level calculated by the sound pressure level calculating part 12a reaches a target sound pressure level. Specifically, the target sound pressure level determining part 12c determines whether a sound pressure level (after the noise from outdoors is absorbed by the sound absorptivity variable member 14) reaches the target sound pressure level. If it is determined by the target sound pressure level determining part 12c that the target sound pressure level is not reached, then the stimulus source control part 12 is configured to generate a new stimulus source control signal by referring to the frequency of the indoor noise detected by the noise detecting part 11b and the table for generating the stimulus source control signal.

The noise control device 30 of the third embodiment employs a feedback function in addition to the function of the noise control device 10 shown in FIG. 1. The noise control device 30 determines whether the indoor noise changed by the sound absorptivity variable member 14 is changed to the target sound pressure level by means of the target sound pressure level determining part 12c. The noise control device 30 then generates a new stimulus source control signal based on the frequency of the noise detected by the indoor noise detecting part 11b if the indoor noise is not changed to the target sound pressure level.

Next, the operational procedures of the noise control device constructed in accordance with the third embodiment are explained with reference to the operational flow chart of FIG. 8. The third embodiment also illustrates an example wherein the sound absorptivity variable member 14, the sound absorptivity of which is changed by receiving an electric stimulus (e.g., voltage), is applied to a vehicle. In FIG. 8, an explanation of operation procedures identical to those of FIG. 2 is omitted herein.

Further, although application to s vehicle is explained below, the invention is not limited thereto and may be applied to any place requiring noise reduction.

As shown in FIG. 8, the noise generated from the noise source is first detected by the outdoor noise detecting part 11a in step S31. The detected noise is converted into an electrical signal and transmitted to the stimulus source control part 12.

Next, the stimulus source control part 12 receives a signal from the outdoor noise detecting part 11a and generates a stimulus source control signal based on the received signal at step S32. Also, the stimulus source control part 12 transmits the generated stimulus source control signal to the stimulus source providing part 13 at step S33.

Next, at step S34, the stimulus source providing part 13 receives the stimulus source control signal from the stimulus source control part 12 and generates the electric stimulus (e.g., voltage) assigned to the sound absorptivity variable member 14 based on the received stimulus source control signal. Then, the stimulus source providing part 13 outputs the generated electric stimulus to the sound absorptivity variable member 14.

Thereafter, the sound absorptivity variable member 14 receives the electric stimulus outputted from the stimulus source providing part 13, thereby changing the sound absorptivity against the noise at step S35.

At next step S36, the indoor noise of a vehicle is detected by the indoor noise detecting part 11b. The noise detected by the indoor noise detecting part 11b is converted into an electrical signal proportional to the magnitude thereof and transmitted to the stimulus source control part 12. Further, although a place for arranging the indoor noise detecting part 11b is not limited, the indoor noise detecting part 11b is arranged at a place where the vehicular indoor noise can be effectively detected.

Then, the stimulus source control part 12 determines whether the frequency of the noise detected by the indoor noise detecting part 11b reaches a target sound pressure level at step S37. If the frequency does not reach the target sound pressure level as indicated by step S37, then the process returns to step S22. At this time, the stimulus source control part 12 is configured to generate the stimulus source control signal based on the frequency of the noise detected by the indoor noise detecting part 11b. Then, the stimulus source control part 12 transmits the generated stimulus source control signal to the stimulus source providing part 13, and the processes below step S23 are performed again. However, when the frequency reaches or falls below the target sound pressure level, that is, the response to the query of step S37 is “YES,” the process ends.

According to the noise control device of the third embodiment, the vehicular outdoor noise is detected by the outdoor noise detecting part 11a, and the stimulus source assigned to the sound absorptivity variable member 14 is controlled. Then, the vehicular indoor noise after absorbing the sound is detected by the indoor noise detecting part 11b. When the frequency of the noise does not reach the target frequency, a feedback control is performed to thereby newly generate a stimulus source assigned to the sound absorptivity variable member 14. Thus, it becomes possible to ensure quietness.

Although the first to third embodiments explain the electric stimulus as the stimulus source, the invention is not limited thereto. The sound absorptivity variable member 14, which changes the sound absorptivity in response to other stimulus sources such as temperature, humidity, light or magnetic source, may be used in the invention.

Embodiments of the noise control device of the invention are further explained below based on the following examples, which are described in order to facilitate the understanding of the invention. The technical range of the invention is not limited to such examples. In the examples and comparison examples, the present invention is applied to a vehicle.

### First Example

In the first example, a microphone is used and installed within a front pillar as the vehicular indoor noise detecting part 11. A control circuit is a portion of the stimulus source control part 12 and is configured to have a transmission function for a relationship between the installation location of the microphone and the head rest neighborhood of the vehicle. The stimulus source providing part 13 is electrically connected to the sound absorptivity variable member 14 by using a direct current stabilization power source (“AD-8735D” produced by A&D Co., Ltd. in this example).

Further, an air flow rate variable fabric formed by a conductive polymer is used in the sound absorptivity variable part 14. The air flow rate variable fabric is obtained by the manufacturing method disclosed in Japanese Laid-Open Patent Application No. 2007-277791. The air flow rate variable fabric obtained by such manufacturing method is formed to have a thickness of 10 mm and an area density of 1000 g/cm² and is installed on the head linings of a driver seat and a passenger seat to have a side of 30 cm, respectively (0.09 m²) (see FIG. 4). The SKYLINE (“V35” produced by Nissan Motors Company) is used as the vehicle.

### Second Example

In the second example, the stimulus source control part 12, the stimulus source providing part 13, the sound absorptivity variable member 14 (including its installation location) and the vehicle are the same as in the first example. As for the indoor noise detecting part 11b, a microphone is used and installed at 5 cm from a center console wall surface and a dash panel of the driver seat side to a vehicular indoor side and a height of 20 cm from a vehicular indoor floor surface.

### Third Example

In the third example, the stimulus source control part 12, the stimulus source providing part 13, the sound absorptivity variable member 14 (including its installation location) and the vehicle are the same as in the first example. As for the outdoor noise detecting part 11a, a microphone for detecting the noise of an engine mounted in a vehicle is used and installed on an engine cover.

### Fourth Example

In the fourth example, the stimulus source control part 12, the stimulus source providing part 13, the sound absorptivity variable member 14 (including its installation location) and the vehicle are the same as in the first example. The outdoor noise detecting part 11a is installed on the engine cover as in the third example. Further, the microphone as the indoor noise detecting part 11b is used and installed at 5 cm from a center console wall surface and a dash panel of the driver seat side to a vehicular indoor side and a height of 20 cm from a vehicular indoor floor surface, which is the same as in the second example.

### Fifth Example

In the fifth example, the stimulus source control part 12, the stimulus providing part 13, the noise detecting part 11a and 11b and the vehicle are the same as in the fourth example.

Further, as for the sound absorptivity variable member 14, an elastic modulus variable fabric formed by a conductive polymer is used. The elastic modulus variable fabric is obtained by the manufacturing method disclosed in Japanese Laid-Open Patent Application No. 2007-277791. The elastic modulus variable fabric obtained by such manufacturing method is formed to have a thickness of 2 mm and an area density of 1500 g/cm². Two sheets of the elastic modulus fabric having a diameter of 10 cm are installed at the rear surface side of a skin material of a head rest in the driver seat and the passenger seat, respectively. Thus, a total of four sheets is installed (see FIG. 3).

### Sixth Example

In the sixth example, the stimulus source control part 12, the stimulus source providing part 13, the noise detecting part 11a and 11b and the vehicle are the same as in the fourth example.

Further, as for the sound absorptivity variable member 14, an elastic modulus variable film formed by a conductive polymer is used. The elastic modulus variable film is obtained by the manufacturing method disclosed in Japanese Patent Publication Nos. 3039994 and 3102773. The elastic modulus variable film obtained by such method is formed to have a thickness of 200 μm. Two sheets of the elastic modulus film having a size of φ 10 cm are installed at the rear surface side of a skin material of a head rest in the driver seat and the passenger seat, respectively. Thus, a total of four sheets is installed (see FIG. 3).

### Seventh Example

In the seventh example, the stimulus source control part 12, the stimulus providing part 13, the noise detecting part 11a and 11b and the vehicle are the same as in the fourth example.

Further, as for the sound absorptivity variable member 14, an air flow rate variable fabric is formed by a conductive polymer to have a thickness of 10 mm and an area density of 1000 g/cm² and is installed on the head lining of the driver seat and the passenger seat, respectively, to have a size of 0.09 m² (see FIG. 4).

### Eighth Example

In the eighth example, the noise detecting part 11b, the stimulus source control part 12, the stimulus source providing part 13, the sound absorptivity variable member 14 (including its installation location) and the vehicle are the same as in the second example. The operational processes are performed as in the second embodiment.

### Ninth Example

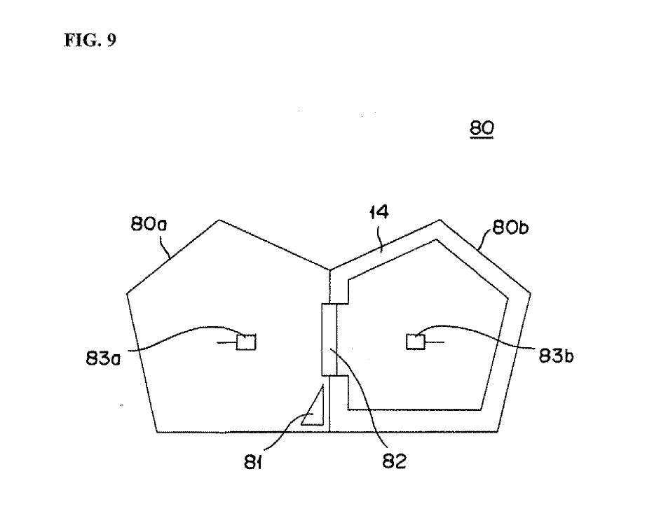

In the ninth example, an evaluation is performed by using a measuring device 80 shown in FIG. 9. The measuring device is configured to have a structure obtained from scaling down a transmission loss detecting device according to JISA1416. The measuring device comprises two reverberation boxes 80a and 80b and a compartment 82 separating the reverberation boxes 80a and 80b. Further, a speaker 81 as a sound source is installed in one reverberation box 80a. As for the compartment 82, an acryl plate having a thickness of 1 cm is used, which is the same material as that for forming an outer surface of the measuring device 80. Also, sound pressure measuring devices 83a and 83b for detecting the sound pressure are assembled in the reverberation boxes 80a and 80b, respectively.

Further, as for the sound absorptivity variable member 14, an air flow rate variable fabric formed by a conductive polymer is used. The air flow rate variable fabric is obtained by the manufacturing method disclosed in Japanese Laid-Open Patent Application No. 2007-277791. The air flow rate variable fabric obtained by such manufacturing method is formed to have a thickness of 20 mm and an area density of 800 g/cm² and is installed in an entire surface of an inner wall of the reverberation box 80b except for the compartment 82.

In the evaluation method according to JISA1416, a transmission loss TL (dB) is provided by the following formula as a sound pressure difference measured by the sound pressure measuring devices 83a and 83b, that is, a difference between a sound pressure value I (dB) at a side with the sound source (reverberation box 83a) and a sound pressure value H (dB) at a side without the sound source (reverberation box 83b):
TL(dB)=I(dB)−H(dB).

### First Comparison Example

In the first comparison example, a resonator for 640 Hz in the form of a plate having a thickness of 0.1 cm is produced by preparing a container having an inner volume of 3.125 cm³ (length of 2.5 cm, width of 2.5 cm and height of 0.5 cm) and opening a hole having a diameter of 0.1 cm in an upper surface of the container. A total of 50 resonators is prepared in order to install 25 resonators at positions corresponding to the left and right ear positions of the passenger in the head rest, respectively (see FIG. 3). The total volume is 78 cm³. The resonators are installed in the vehicle, which is the same as in the first to nine examples, during a normal driving at a speed of 60 km/h. Then, the sound pressure value at the human ear position is measured.

### Second Comparison Example

Similar to the first comparison example, a resonator for 1000 Hz in the form of a plate having a thickness of 0.1 cm is produced by preparing a container having an inner volume of 1.5625 cm³ (length of 2.5 cm, width of 2.5 cm and height of 0.25 cm) and opening a hole having a diameter of 0.1 cm in an upper surface of the container. A total of 50 resonators is prepared in order to install 25 containers at positions contacting the right and left ear positions in the head rest, respectively. The total volume is 39 cm³.

### Experimental Example

In the first to ninth examples, as well as the first and second comparison examples, the vehicles are driven in a normal operation at a speed of 30 km/h and 60 km/h along a straight road. The sound pressure level difference between the noise source (at the position of the noise detecting part) and an ear sound pressure (at a position 15 cm front of the head rest of the driver seat) is recorded for 30 seconds. The sound is recorded for cases using and not using the noise control device of the invention. Then, the sounds are fast Fourier converted (using FFT), indicated as a sound pressure level difference in each ⅓ octave band, and compared to each other. The measured results in each example and comparison example are indicated in Table 1 below.

TABLE 1

| | | | | Driving | | |
|---|---|---|---|---|---|---|
| | Noise detecting | Sound field variable | Installing | conditions | [symbol] | Volume |
| | means | member | place | (km/h) | control ON/OFF | change |
| First | Vehicular | Fabric formed by the | Head lining | 30 | Control OFF | — |
| Example | outdoor | conductive polymeric | | | Control ON | No |
| | | fiber | | 60 | Control OFF | — |
| | | | | | Control ON | No |
| Second | Vehicular | Fabric formed by the | Head lining | 30 | Control OFF | — |
| Example | indoor | conductive polymeric | | | Control ON | No |
| | | fiber | | 60 | Control OFF | — |
| | | | | | Control ON | No |
| Third | Engine | Fabric formed by the | Head lining | 30 | Control OFF | — |
| Example | | conductive polymeric | | | Control ON | No |
| | | fiber | | 60 | Control OFF | — |
| | | | | | Control ON | No |
| Fourth | Vehicular | Fabric formed by the | Head lining | 30 | Control OFF | — |
| Example | outdoor | conductive polymeric | | | Control ON | No |
| | Engine | fiber | | 60 | Control OFF | — |
| | | | | | Control ON | No |
| Fifth | Vehicular | Fabric formed by the | Head lining | 30 | Control OFF | — |
| Example | outdoor | conductive polymeric | | | Control ON | No |
| | Engine | fiber | | 60 | Control OFF | — |
| | | | | | Control ON | No |
| Sixth | Vehicular | Conductive flim | Head [symbol] | 30 | Control OFF | — |
| Example | outdoor | | | | Control ON | No |
| | Vehicular | | | 60 | Control OFF | — |
| | outdoor | | | | Control ON | No |
| Seventh | Vehicular | Fabric formed by the | Head lining | 30 | Control OFF | — |
| Example | outdoor | conductive polymeric | | | Control ON | No |
| | | fiber | | | | |
| | Engine | Fabric formed by the | Head [symbol] | 60 | Control OFF | — |
| | | conductive polymeric | | | Control ON | No |
| | | fiber | | | | |
| First | — | [symbol] | Head [symbol] | 30 | Non-installed | — |
| Comparison | | | | | Installed | 78 cm3 |
| Example | | | | 60 | Non-installed | — |
| | | | | | Installed | 78 cm3 |
| Second | — | [symbol] | Head [symbol] | 30 | Non-installed | — |
| Comparison | | | | | Installed | 78 cm3 |
| Example | | | | 60 | Non-installed | — |
| | | | | | Installed | 78 cm3 |
| Eighth | Vehicular indoor | Fabric formed by the | Head lining | 30 | Control OFF | — |
| Example | threshold control | conductive polymeric | | | Control ON | No |
| | | fiber | | 60 | Control OFF | — |
| | | | | | Control ON | No |
| Ninth | Indoor | Fabric formed by the | Inside the | — | Control OFF | — |
| Example | | conductive polymeric | [symbol] | | Control ON | No |
| | | fiber | box | | | |

| | Sound pressure level difference in each frequency band [dB] | | | | | | | | | |
|---|---|---|---|---|---|---|---|---|---|---|
| | 200 | 256 | 315 | 400 | 500 | 630 | 800 | 1000 | 1250 | 1500 |
| | 47.0 | 43.0 | 4 [symbol] .0 | 47.1 | 43.0 | 49.0 | 43.0 | 42.0 | 40.3 | 42.0 |
| First | 46.7 | 43.0 | 43.7 | 48.3 | 43.3 | 43.5 | 42.2 | 41.5 | 40.0 | 41.6 |
| Example | 46. [symbol] | 43.0 | 48.6 | 48.3 | 43.2 | 48.2 | 43.6 | 46.6 | 41.8 | 41.3 |
| | 46.3 | 43.3 | 43.8 | 48.3 | 43.2 | 44.9 | 42.9 | 44.2 | 41.1 | 41.5 |
| | 35.0 | 31.0 | 2 [symbol] .0 | 33.1 | 31.0 | 33.0 | 31.0 | 30.0 | 28.0 | 30.0 |
| Second | 34.7 | 31.0 | 3.9 | 34.3 | 30.2 | 33.5 | 30.3 | 29.5 | 28.0 | 30.0 |
| Example | 34.4 | 31.1 | 34.0 | 34.6 | 31.0 | 34.3 | 31.5 | 34.7 | 30.0 | 29.3 |
| | 34.4 | 31.2 | 34.1 | 34.4 | 31.0 | 32.9 | 3.8 | 32.1 | 29.5 | 29.5 |
| | 60.3 | 46.0 | 59.2 | 59.7 | 53.2 | 61.3 | 55.8 | 55.3 | 53.3 | 55.0 |
| Third | 59.3 | 55.6 | 58.7 | 59.0 | 5 [symbol] .3 | 58.7 | 54.8 | 54.5 | 53.1 | 54.3 |
| Example | 60.1 | 56.3 | 59.0 | 59.8 | 56.0 | 59.2 | 56.5 | 59.7 | 54.6 | 54.3 |
| | 59.0 | 56.1 | 58.7 | 59.4 | 56.0 | 57.9 | 55.8 | 57.1 | 54.1 | 54.3 |
| | 47.0 | 43.0 | 46.0 | 47.1 | 43.0 | 49.9 | 43.0 | 42.0 | 46.2 | 42.0 |
| Fourth | 46.1 | 42.3 | 44.3 | 43.3 | 42.3 | 43.7 | 41.6 | 40.5 | 38.3 | 39.0 |
| Example | 46.2 | 42.9 | 43.9 | 48.8 | 43.3 | 46.2 | 43.6 | 46.6 | 41.8 | 41.3 |
| | 45.3 | 41.9 | 43.3 | 45.0 | 42.3 | 43.6 | 42.4 | 43.2 | 40.0 | 39.8 |
| | 46.0 | 42.0 | 49.0 | 48.1 | 42.0 | 48.0 | 42.0 | 41.0 | 39.0 | 41.0 |
| Fifth | 45.3 | 42.0 | 44.9 | 43.3 | 41.2 | 40.4 | 41.2 | 40.5 | 39.0 | 41.0 |
| Example | 45.4 | 42.0 | 45.0 | 45.8 | 42.0 | 45.2 | 42.5 | 45.7 | 40.8 | 40.3 |
| | 45.4 | 41.9 | 45.2 | 45. [symbol] | 42.0 | 43.9 | 41.8 | 43.1 | 40.3 | 40.3 |
| | 46.3 | 42.3 | 45.1 | 43.9 | 43.1 | 47.9 | 41.9 | 41.2 | 39.2 | 41.0 |
| Sixth | 45.7 | 42.3 | 44.9 | 43.3 | 41.3 | 44.5 | 41.2 | 40.5 | 39.1 | 41.0 |
| Example | 45.8 | 42.1 | 45.1 | 45.6 | 42.1 | 45.3 | 42.6 | 45.7 | 40.9 | 40.5 |
| | 45. [symbol] | 42.1 | 44.9 | 45. [symbol] | 42.0 | 43.9 | 41.8 | 43.1 | 40.3 | 40.5 |
| | 45. [symbol] | 41.9 | 44.8 | 45.8 | 43.4 | 47.4 | 41.7 | 40.9 | 39.0 | 40.7 |
| Seventh | 44.1 | 41.4 | 43.8 | 45.0 | 40.6 | 40.2 | 29.3 | 29.0 | 37.5 | 39.9 |
| Example | 45.4 | 42.0 | 43.3 | 43.3 | 43.0 | 45.1 | 42.5 | 45.7 | 40.9 | 40.4 |
| | 44.7 | 40.3 | 44.6 | 44.9 | 41.1 | 42.9 | 40.7 | 40.7 | 39.3 | 39.5 |
| | 48.4 | 43.0 | 46.6 | 46.6 | 43.0 | 48.9 | 44.5 | 45.0 | 42.2 | 41.3 |
| First | 46.3 | 43.0 | 46.3 | 48.8 | 44.3 | 43.8 | 45.5 | 45.3 | 43.4 | 41.5 |
| Comparison | 47.0 | 43.0 | 46.0 | 47.1 | 43.0 | 47.3 | 44.8 | 47.3 | 42.5 | 42.0 |
| Example | 46.7 | 43.0 | 45.9 | 47.0 | 44.4 | 44.7 | 45.4 | 47.1 | 42.2 | 41.8 |
| | 46.4 | 43.0 | 46.6 | 46.6 | 43.0 | 46.2 | 43.5 | 46.7 | 41.8 | 41.3 |
| Second | 46.3 | 43.3 | 45.6 | 48.8 | 43.9 | 48.3 | 44.7 | 44.1 | 43.1 | 42.5 |
| Comparison | 46.7 | 43.0 | 46.0 | 47.1 | 42.9 | 47.0 | 44.8 | 47.4 | 42.8 | 41.9 |
| Example | 46.7 | 43.0 | 45.9 | 47.1 | 42.3 | 48.2 | 45.5 | 44.1 | 44.1 | 43.7 |
| | 47.1 | 43.0 | 46.0 | 47.2 | 43.0 | 49.1 | 43.1 | 42.1 | 40.3 | 43.0 |
| Eighth | 46.7 | 43.0 | 45.7 | 46.3 | 42.3 | 47.3 | 43.7 | 41.5 | 40.0 | 41.6 |
| Example | 46.4 | 43.0 | 46.6 | 46.8 | 43.2 | 46.3 | 43.6 | 46.9 | 41.8 | 41.3 |
| | 46.2 | 43.2 | 45.8 | 46.3 | 43.2 | 45.8 | 42.9 | 45.7 | 41.1 | 41.5 |
| | 2.1 | 3.0 | 2.6 | 1.9 | 2.1 | 2.8 | 1.9 | 2.0 | 1.1 | 0.7 |
| Ninth | 1.9 | 2. [symbol] | 3.4 | 1.8 | 1.8 | 2.0 | 1.8 | 1.6 | 0.8 | 0.3 |
| Example | | | | | | | | | | |

In the present examples, the noise reduction is focused in a frequency band of 630 Hz when the driving speed is 30 km/h. When the driving condition is 60 km/h, the noise reduction is focused in a frequency band of 1 kHz. That is, for the vehicle used in the present examples, the frequency bands are those required to reduce the noise. Referring to Table 1, when using the sound absorptivity variable member 14 in the first to ninth examples, significant sound absorbing effects can be obtained according to the sound pressure level difference between before providing the stimulus source (stimulus source control off) and after providing the stimulus source (stimulus source control on). The sound absorbing effects are not significantly recognized in the frequency band of 1 kHz in the first comparison example and the frequency band of 630 Hz in the second comparison example. However, the sound absorbing effects are significantly recognized in both frequency bands of each example using embodiments of the invention. Thus, since the noise control device of the present invention can effectively reduce the noise throughout a broader frequency band, it is possible to increase the silence compared to the known devices.

Further, when installing the resonator structure in the head rest, there is discomfort when the head portion contacts the head rest. However, in the invention the sound absorptivity variable member can be installed as a replacement material of a cushion or backing material and is not a rigid material. Therefore, there is no discomfort although the sound absorptivity variable member is installed in a region contacting human beings. Accordingly, it is also effective to apply the invention to regions contacting human beings.

The above-described embodiments have been described in order to allow easy understanding of the invention and do not limit the invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A noise control device, comprising:
a noise detecting part configured and arranged to detect a noise generated from a noise source;
a stimulus source control part configured to output a stimulus source control signal according to a frequency of the noise;
a stimulus source providing part configured to provide a stimulus source based on the stimulus source control signal; and
a sound absorptivity variable member configured to change sound absorptivity against the noise in response to receiving the stimulus source.

2. The noise control device according to claim 1 wherein the stimulus source control part further comprises:
a first sound pressure level calculating part configured to analyze a frequency of the noise and to calculate a sound pressure level for each frequency of the noise; and
a threshold determining part configured to determine whether the sound pressure level reaches a threshold sound pressure level; and wherein
the stimulus source control part is configured to output the stimulus source control signal to the stimulus source providing part when the threshold determining part determines the sound pressure level reaches the threshold sound pressure level.

3. The noise control device according to claim 1, further comprising:
a second noise detecting part configured and arranged to detect noise after sound is absorbed by the sound absorptivity variable member; and wherein the stimulus source control part includes:
a sound pressure level calculating part configured to analyze a frequency of the noise detected by the second noise detecting part and to calculate a sound pressure level for each frequency; and
a sound pressure level determining part configured to determine whether the sound pressure level reaches a target sound pressure level; and wherein
the stimulus source control part is configured to output to the stimulus source providing part a new stimulus source control signal according to the frequency of the noise detected by the second noise detecting part when the sound pressure level does not reach the target sound pressure level.

4. The noise control device according to claim 3 wherein the sound absorptivity variable member is an elastic modulus variable fabric or an elastic modulus variable film configured to change an elastic modulus and the sound absorptivity against the noise in response to the electric stimulus.

5. The noise control device according to claim 1 wherein the stimulus source is an electric stimulus.

6. The noise control device according to claim 5 wherein the sound absorptivity variable member is an air flow rate variable fabric configured to change an air flow rate and the sound absorptivity against the noise in response to the electric stimulus.

7. The noise control device according to claim 1 wherein the sound absorptivity variable member is an air flow rate variable fabric configured to change an air flow rate and the sound absorptivity against the noise in response to the stimulus source.

8. The noise control device according to claim 1 wherein the sound absorptivity variable member is an elastic modulus variable fabric or an elastic modulus variable film configured to change an elastic modulus and the sound absorptivity against the noise in response to the stimulus source.

9. The noise control device according to claim 1 wherein the sound absorptivity variable member is a combination of at least two or more of an air flow rate variable fabric, an elastic modulus variable fabric and an elastic modulus variable film.

10. The noise control device according to claim 1 wherein the sound absorptivity variable member comprises a stimulus responsive polymer.

11. A vehicle comprising the noise control device according to claim 1.

12. A noise control method, comprising:
detecting a noise generated from a noise source;
outputting a stimulus source control signal according to a frequency of the noise; and
providing a stimulus source based on the stimulus source control signal to a sound absorptivity variable member configured to change sound absorptivity against the noise in response to receiving the stimulus source.

13. The noise control method according to claim 12, further comprising:
analyzing a frequency of the noise;
calculating a sound pressure level for each frequency of the noise;
determining whether the sound pressure level reaches a threshold sound pressure level; and
outputting the stimulus source control signal when the sound pressure level reaches the threshold sound pressure level.

14. The noise control method according to claim 12 wherein detecting the noise generated from the noise source includes detecting the noise at a first location, the method further comprising:
detecting noise at a second location after sound is absorbed by the sound absorptivity variable member;
analyzing a frequency of the noise detected at the second location;
calculating a sound pressure level for each frequency of the noise detected at the second location;
determining whether the sound pressure level reaches a target sound pressure level; and
outputting a new stimulus source control signal according to the frequency of the noise detected at the second location when the sound pressure level does not reach the target sound pressure level.

15. The noise control method according to claim 12 wherein providing the stimulus source comprises providing an electric stimulus.

16. The noise control method according to claim 12 wherein the sound absorptivity variable member is at least one of.
an air flow rate variable fabric configured to change an air flow rate and the sound absorptivity against the noise in response to the stimulus source;
an elastic modulus variable fabric configured to change an elastic modulus and the sound absorptivity against the noise in response to the stimulus source;
an elastic modulus variable film configured to change an elastic modulus and the sound absorptivity against the noise in response to the stimulus source; and
a stimulus responsive polymer.
